(19) United States
(12) Patent Application Publication
(10) Pub. No.: US 2010/0036915 A1
(43) Pub. Date: Feb. 11, 2010

(54) Client, Computer-Readable Medium, and Method for Acquiring URI

(75) Inventors: Yong Woon Kim, Chungcheongnam-do (KR); Jun Seob Lee, Daejeon-city (KR); Sang Keun Yoo, Chungcheongnam-do (KR); Hyoung Jun Kim, Daejeon-city (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications research Institute, Daejeon (KR)

(21) Appl. No.: 12/086,088

(22) PCT Filed: Dec. 5, 2006
(86) PCT No.: PCT/KR2006/005187

§ 371 Date: Sep. 21, 2009

(30) Foreign Application Priority Data
Dec. 9, 2005 (KR) 1020050121044

(51) Int. Cl. G06F 15/16

(52) U.S. Cl. 709/206; 709/245

(57) ABSTRACT

A client, a computer-readable recording medium, and method for acquiring a uniform resource identifier are provided. The client includes a message reception unit which receives a plurality of naming authority pointer (NAPTR) records from a domain name service (DNS) server, each of the NAPTR records comprising a URI and an identifier of a user of the URI; and a URI selection unit which chooses one of the URIs respectively included in the NAPTR records by referencing the identifiers respectively included in the NAPTR records. Accordingly, it is possible to choose a URI to be used by a client from among a plurality of URIs included in URI information received from a DNS server.

### CROSS-REFERENCE TO RELATED PATENT APPLICATION

This application claims the benefit of Korean Patent Application No. 10-2005-0121044, filed on Dec. 9, 2005, in the Korean Intellectual Property Office, the disclosure of which is incorporated herein in its entirety by reference.

### BACKGROUND OF THE INVENTION

1. Field of the Invention

The present invention relates to a method of using uniform resource identifier (URI) information, and more particularly, to a method of determining one of a plurality of URIs included in a domain name service (DNS) response message as a URI to be used by a client with reference to an identifier included in naming authority pointer (NAPTR) information.

2. Description of the Related Art

The Naming Authority Pointer (NAPTR) provides uniform resource identifier (URI) information for phone numbers, barcodes, and Internet domain names comprised of numerals such as radio frequency identification (RFID) code. In other words, the NAPTR aims at displaying a protocol associated with any arbitrary application service and thus eventually displaying the protocol as URI information. An application program of a client (for example, a seller of TVs) converts RFID code “1.2.3.4” of a TV to be sold into a domain name “4.3.2.1.odsroot.or.kr,” and transmits the domain name “4.3.2.1.odsroot.or.kr” to a domain name service (DNS) server. Then, the DNS server transmits a DNS reply message to the client using a DNS protocol, wherein the DNS reply message contains a NAPTR record that comprises a URI set in the domain name “4.3.2.1.odsroot.or.kr.” In general, a DNS reply message comprises one or more URIs. Assuming that a DNS reply message transmitted by a DNS server comprises two NAPTR records and that the two NAPTR records respectively comprise an URI “sip:info@ pbx.example.com” and an URI “mailto:info@example.com,” a client receives information regarding the two URIs by receiving the DNS reply message.

In this case, the client needs to determine which of the two URIs is to be used according to priorities between the two URIs. The priorities between the two URIs may be determined by fields “ORDER” and “PREFERENCE” of an NAPTR record. The aforementioned operating rules do not consider by whom a URI is to be used, i.e., who the client is. The conventional NAPTR specification does not provide information that matches a URI with a client. Thus, when a DNS reply message comprises a plurality of URIs that target different clients, the conventional NAPTR specification may cause inconvenience, and this will hereinafter be described in further detail.

For example, assume that a seller of TVs is supposed to provide TV price information to both customers of an E-Mart and customers of a Wal-Mart and that the price of a predetermined TV is A at the E-Mart and B at the Wal-Mart.

A DNS reply message corresponding to RFID of the predetermined TV is provided to an application program (hereinafter referred to as the E-Mart application program) for a seller of the predetermined TV at the E-Mart and an application program (hereinafter referred to as the Wal-Mart application program) for a seller of the predetermined TV at the Wal-Mart. The DNS reply message comprises a URI indicating the TV price A and a URI indicating the TV price B. In this case, the E-Mart application program and the Wal-Mart application program are required to acquire the TV price A and the TV price B, respectively, from the DNS reply message. However, if the DNS reply message follows the conventional NAPTR specification, the E-Mart application program and the Wal-Mart application program may not be able to determine which of the two URIs included in the DNS reply message is more suitable for them because conventional NAPTR records, in general, simply provide information indicating types of information services provided (e.g., HTTP, FTP, TELENET, and VoIP) without providing information specifying users of such information services.

The aforementioned problem also arises in the situations when there is the need to provide different information services to different types of users such as individuals, organizations, companies, and entrepreneurs.

### SUMMARY OF THE INVENTION

The present invention provides a uniform resource identifier (URI)-based client, a recording medium, and a method for distinguishing an identifier to be used from among a plurality of URIs that are included in a domain name service (DNS) response message as naming authority pointer (NAPTR) records.

According to an aspect of the present invention, there is provided a client for acquiring a uniform resource identifier (URI). The client includes a message reception unit which receives a plurality of naming authority pointer (NAPTR) records from a domain name service (DNS) server, each of the NAPTR records comprising a URI and an identifier of a user of the URI; and a URI selection unit which chooses one of the URIs respectively included in the NAPTR records by referencing the identifiers respectively included in the NAPTR records.

According to another aspect of the present invention, there is provided a computer-readable recording medium storing an NAPTR having a data structure that comprises a URI and an identifier of a user of the URI in order to choose a URI desired by a client from among a plurality of URIs respectively included in a plurality of NAPTR records.

According to another aspect of the present invention, there is provided a method of acquiring a uniform resource identifier (URI) of a client. The method includes receiving a plurality of naming authority pointer (NAPTR) records from a domain name service (DNS) server, each of the NAPTR records comprising a URI and an identifier of a user of the URI; and choosing one of the URIs respectively included in the NAPTR records by referencing the identifiers respectively included in the NAPTR records.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram for illustrating the format of a zone setting file stored in a domain name service (DNS) server;

FIG. 2 is a diagram for illustrating the format of naming authority pointer (NAPTR) records according to an embodiment of the present invention;

FIG. 3A is a diagram for illustrating the format of a field “SERVICES” of an NAPTR record for an E.164 domain name according to an embodiment of the present invention;

FIG. 3B is a diagram for illustrating the format of a field “SERVICE” of an NAPTR record for numerical code according to an embodiment of the present invention;

FIG. 3C is a diagram for illustrating a field “SERVICES” having the format illustrated in FIG. 3B;

FIG. 4 is a diagram for illustrating the format of NAPTR records according to another embodiment of the present invention;

FIG. 5A is a diagram for illustrating a zone setting file of a DNS server that comprises the NAPTR records illustrated in FIG. 4;

FIG. 5B is a diagram for illustrating URI information extracted from the zone setting file illustrated in FIG. 5A;

FIG. 6 is a diagram for illustrating a zone setting file that comprises a plurality of NAPTR records respectively comprising a plurality of identifiers of users of an information service associated with a domain name “50.40.30.20.10.odsroot.or.kr,” according to an embodiment of the present invention;

FIG. 7 is a block diagram of a system for acquiring a URI according to an embodiment of the present invention; and

FIG. 8 is a flowchart illustrating a method of acquiring a URI according to an embodiment of the present invention or an operation of the system illustrated in FIG. 7.

### DETAILED DESCRIPTION OF THE INVENTION

The present invention will now be described more fully with reference to the accompanying drawings in which exemplary embodiments of the invention are shown.

The present invention provides a method and system for identifying information services (i.e., resources) regarding objects such as TVs, movies, or beef using naming authority pointer (NAPTR) records and thus providing a client with appropriate resources regarding an object of the client's interest. In other words, assuming that a client desires to acquire an information service such as history or price information of TVs, movies, or beef and the information service comprises a variety of information, the present invention aims at providing the client with only the information desired by the client.

According to the present embodiment, NAPTR records are used to identify users of information services because NAPTR records can provide uniform resource identifier (URI) information that is set in advance for a predetermined object identified by a number such as a phone number, barcode, or radio frequency identification (RFID) code using a domain name service (DNS) protocol.

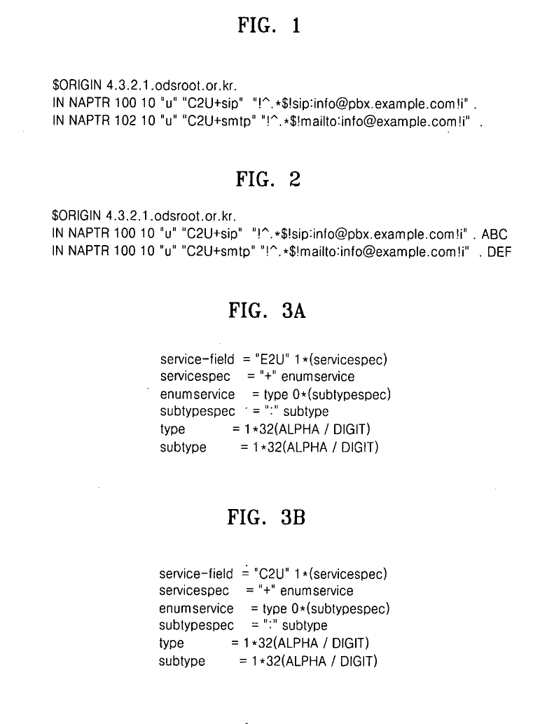

FIG. 1 is a diagram for illustrating a zone setting file stored in a DNS server. A method of acquiring URI information corresponding to RFID code input to a client will hereinafter be described in detail with reference to FIG. 1. Referring to FIG. 1, RFID code “1.2.3.4” is input to a client, and then, the client converts the RFID code “1.2.3.4” into a domain name “4.3.2.1.odsroot.or.kr,” and transmits a DNS query message to a DNS server. The DNS server searches the zone setting file illustrated in FIG. 1 for an NAPTR record that is set for the domain name “4.3.2.1.odsroot.or.kr,” and transmits a DNS response message including the identified NAPTR record to the client. In other words, the DNS server transmits a DNS response message including URI information that is set for the domain name “4.3.2.1.odsroot.or.kr” using a DNS protocol.

Accordingly, the client receives two NAPTR records registered in the zone setting file for the RFID code “1.2.3.4”, and eventually receives two URIs, i.e., “sip:info@ pbx.example.com” and “mailto:info@example.com.”

An NAPTR record comprises six fields, i.e., “ORDER”, “PREFERENCE” “FLAGS”, “SERVICES”, “REGEXP”, and “REPLACEMENT.” The field “SERVICES” stores information regarding application services and protocols, and is used to acquire identification and identification-related information. Referring to FIG. 1, the field “SERVICES”, i.e., “sip+C2U” or “smtp+C2U”, indicates that RFID code is to be converted into a URI and that SIP and SMTP application services are to be provided. Since URI information finally acquired for the domain name “4.3.2.1.odsroot.or.kr” created based on the RFID code “1.2.3.4” is “sip:info@pbx.example.com” and “mailto:info@example.com,” the client can attempt to Voice over Internet Protocol-communicate with a user of the address “info@example.com” using a Session Initiation Protocol (SIP) application, and, if the attempt to VoIP-communicate with the user of the address “info@example.com fails, the client can send email to the user of the address “info@example.com” using a Simple Mail Transfer Protocol (SMTP) application. In this case, priorities between the use of an SIP application and the use of an SMTP application are determined by the fields “ORDER” and “PREFERENCE.” The aforementioned operating principles, however, may not be able to satisfy the demand for providing different information services for different types of users (e.g., individuals, organizations, companies, or entrepreneurs). In other words, conventional NAPTR records may not be able to provide user A with information service a, user B with information service b, and user B with information service c by using the same RFID code.

According to the present embodiment, a plurality of NAPTR records are designed such that a URI desired by a client can be easily distinguished from among a plurality of URIs respectively included in a plurality of NAPTR records. This disclosure will hereinafter present two different methods of designing an NAPTR record, but the present invention is not restricted thereto.

The first method of designing an NAPTR record is a method of expanding an existing NAPTR record format by adding one or more fields to the existing NAPTR record format. The format of a typical NAPTR record is prescribed in Requests for Comments (RFC) 3403. According to RFC 3403 standard, an NAPTR record comprises six fields “ORDER”, “PREFERENCE”, “FLAGS”, “SERVICES”, “REGEXP”, and “REPLACEMENT.” According to the present embodiment, a new field, for example, a field “SERVICE_USER”, is added to a typical NAPTR record format, and is used as an identifier.

FIG. 2 is a diagram for illustrating the format of an NAPTR record according to an embodiment of the present invention. NAPTR records illustrated in FIG. 2 are obtained by adding an identifier of a user of an URI to each of the NAPTR records illustrated in FIG. 1 as a seventh field.

Referring to FIG. 2, “ABC” and “DEF,” which are respectively added to the upper and lower NAPTR records illustrated in FIG. 1, indicate users of information services. Since a client knows about the purpose of use of the client, the client can choose an NAPTR record appropriate for the client from among a plurality of NAPTR records, and finally can provide information services based on URI information set for the chosen NAPTR record. For example, if the client is an E-Mart shopping application program, the client knows that it is to be used by an E-Mart. If the client is an Internet banking application program, the client knows about a bank that uses the client.

The second method of designing an NAPTR record is a method of using a field “SERVICES” of an existing NAPTR record to specify application services and protocols provided. The second method of designing an NAPTR record, unlike the first method of designing an NAPTR record, is highly compatible with existing systems because most systems adopt an existing NAPTR record format comprising six fields.

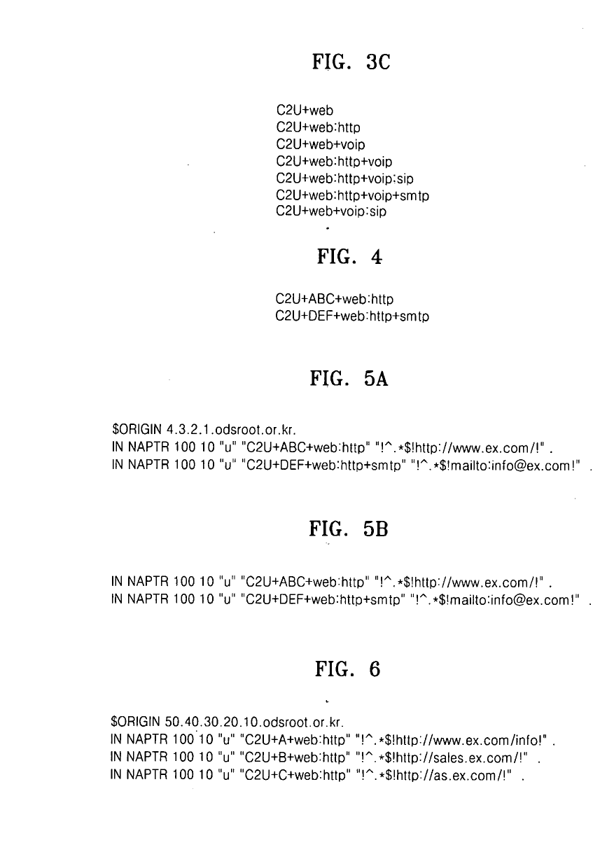

FIG. 3A is a diagram for illustrating the form a to a field “SERVICES” of an NAPTR record for an E.164 domain name according to an embodiment of the present invention, and FIG. 3B is a diagram for illustrating the form a to a field “SERVICES” of an NAPTR record for numerical code according to an embodiment of the present invention. The format of a field “SERVICES” of an NAPTR record may be varied according to the purpose of use of the NAPTR record. The format of a field “SERVICES” of an NAPTR record that transmits an URI representing an E.164 domain name is as illustrated in FIG. 3A, according to RFC 3760. The format of a field “SERVICES” of an NAPTR record that transmits an URI representing RFID code is as illustrated in FIG. 3B and is almost the same as the format illustrated in FIG. 3A.

FIG. 3C is a diagram for illustrating a field “SERVICES” having the format illustrated in FIG. 3 B. Referring to FIG. 3C, information regarding application services or related protocols is determined by the combination of “type” and “subtype.” Referring to FIG. 3C, examples of the information regarding application services or related protocols include “web”, “web:hftp”, “voip”, “voip:sip”, and “smtp.”

“type” in a field “SERVICES” may be extended to indicate not only the types of application services provided but also the identities of users of such application services, i.e., the identities of users of URIs, thereby supporting indication of final targets of information services.

In principle, a field “SERVICES” of an NAPTR record can be interpreted in such a manner that, of a plurality of services specified in the field “SERVICES, the services that cannot be interpreted are ignored and that the services that can be interpreted are chosen and performed. Likewise, of a plurality of services specified in the case of a field “SERVICES” of an NAPTR record that is extended to indicate various application service-related information, only the services that can be interpreted and are needed are chosen, and then selectively performed, regardless of whether a given application program supports all the services specified in the field “SERVICES.”

For example, assume that a field “SERVICES” of an NAPTR record comprises a value ‘C2U+web:http+voip+smtp” and an application program that receives the NAPTR record does not provide functions for processing “voip” and “smtp.” In this case, the application program determines “voip” and “smtp” to be interpretable elements, and thus ignores “voip” and “smtp.” On the other hand, the application program can interpret “web:http” and thus perform a web-related application service operation.

Likewise, if “type” of a field “SERVICES” of an NAPTR record is extended to indicate the identities of users of information services, then “type” may be defined differently for different service targets according to RFC, ITU-T Recommendation, or ISO/IEC International Standard. For example, “type” may be defined as “ABC” for a service target ABC and “DEF” for an entrepreneur DEF, respectively. Thereafter, an application program that needs to distinguish various types of users of a service from one another may be designed based on the aforementioned definitions of “type,” thereby providing users with information services that suit them most.

Examples of standards regarding the application of “type” include RFC 4002. According to RFC 4002, two types of services, i.e., web services and file transmission/reception services, may be respectively represented by “web” and “fp.” When using the combination of “type” and “subtype,” web services and file transmission/reception services may be respectively represented by “web:http” and “fp:ftp.”

FIG. 4 is a diagram for illustrating the format of NAPTR records according to another embodiment of the present invention and explains a method of displaying an identifier of a user of an information service using a field “SERVICES” of an NAPTR record.

FIG. 5A is a diagram for illustrating a zone setting file of a DNS server that comprises the NAPTR records illustrated in FIG. 4. Referring to FIG. 5A, a plurality of NAPTR records are registered with a zone setting file. In this case, in order to learn about all application services available for RFID code “1.2.3.4,” an application program may convert the RFID code “1.2.3.4” into a domain name “4.3.2.1.odsroot.or.kr,” and request NAPTR record information to a DNS server using the domain name “4.3.2.1.odsroot.or.kr.”

The application program may interpret each of a plurality of values included in an NAPTR record. In particular, the application program may discover a parameter “ABC” during the interpretation of a field “SERVICES of the upper NAPTR record illustrated in FIG. 5A, and recognize that the parameter “ABC” is an identifier of a user of an information service. If the application program is an application program designed for ABC, then the application program may perform web application services that are specified in the upper NAPTR record following the parameter “ABC.” On the other hand, if the application program is not an application program designed for ABC, then the application program may ignore the web application services. Likewise, if the application program is an application program designed for DEF, then the application program may support web or email services that are specified in the lower NAPTR record following a parameter “DEF,” and send email to an email address specified in the lower NAPTR record using URI information.

FIG. 6 is a diagram for illustrating a zone setting file that comprises a plurality of NAPTR records respectively comprising a plurality of identifiers of users of an information service associated with a domain name “50.40.30.20.10.odsroot.or.kr,” according to an embodiment of the present invention.

For example, assume that an information service associated with refrigerators is provided, there is the need to diversify content for different types of users of the content such as a customer, a manager of a cut-price store (e.g., a Hi-Mart), and a refrigerator repairman who works for a refrigerator manufacturer. In other words, for a refrigerator identified by numerical code “10.20.30.40.50,” a customer must be provided with information indicating how to use the refrigerator, a refrigerator salesperson must be provided with price information and discount information, and a refrigerator repairman must be provided with information regarding the structure of the refrigerator, information indicating how to detect defects in the refrigerator, and information indicating how to repair the refrigerator. For this, an application program of each user of the refrigerator may convert the numerical code “10.20.30.40.50” into a domain name “50.40.30.20.10.odsroot.or.kr,” and request NAPTR information to a DNS server using the domain name “50.40.30.20.10.odsroot.or.kr.” Then, the DNS server searches the zone setting file illustrated in FIG. 6 for the NAPTR information requested by the application program, and returns the identified NAPTR information to the application program.

In this case, an application program of a customer knows that it is for customers, and thus chooses an NAPTR record having an identifier indicating customers from among a plurality of NAPTR records included in the zone setting file; an application program of a refrigerator salesperson knows that it is for refrigerator salespeople, and thus chooses an NAPTR record having an identifier indicating refrigerator salespeople from among the NAPTR records included in the zone setting file; and an application program of a refrigerator repairman knows that it is for refrigerator repairmen, and thus chooses an NAPTR record having an identifier indicating refrigerator salespeople from among the NAPTR records included in the zone setting file. In this manner, it is possible to provide different information service content for the same information service object to different types of users.

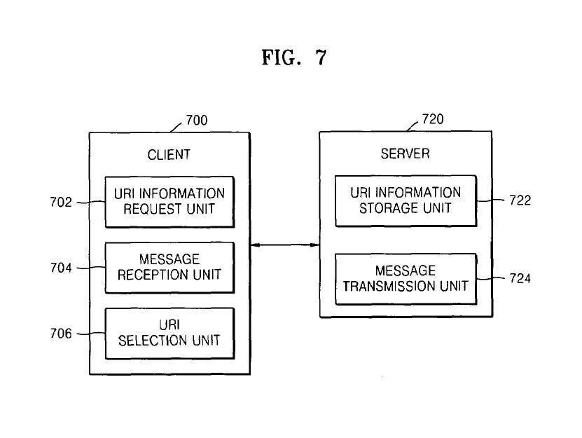

FIG. 7 is a block diagram of a system for acquiring a URI according to an embodiment of the present invention. Referring to FIG. 7, the system includes a client 700 and a server 720.

The client 700 includes a URI information request unit 702, a message reception unit 704, and a URI selection unit 706. The server 720 includes a URI information storage unit 722 and a message transmission unit 724. According to the present embodiment, URIs are transmitted, received, and stored as NAPTR records.

The URI information request unit 702 transmits a signal indicating URI information that is requested by the client 700 to the server 720. If the server 720 is a DNS server, the signal transmitted by the URI information request unit 702 may be a DNS query message containing an NAPTR record.

The URI information storage unit 722 stores at least one NAPTR information, each NAPTR information comprising a URI and an identifier of a user of the URI. Each NAPTR information stored in the URI information storage unit 722 may further include information indicating the types of services using a URI and information indicating at least one platform using the URI. If URI information is generated as an NAPTR record, the identifier of the URI may be recorded in a seventh field of the NAPTR record, as illustrated in FIG. 2, or may be recorded in a field ‘SERVICES’ of the NAPTR record, as illustrated in FIG. 4. However, the present invention is not restricted to this.

The message transmission unit 724 extracts NAPTR information corresponding to URI information requested by the client 700 from the URI information storage unit 722 with reference to the signal transmitted by the URI information request unit 702, and transmits a message including the extracted NAPTR information to the client 700. If the server 720 is a DNS server, then the message transmission unit 724 may extract NAPTR information (as illustrated in FIG. 5B) corresponding to the requested URI information from a zone setting file (as illustrated in FIG. 5A) present in the URI information storage unit 722 based on a DNS query message, and transmit the extracted NAPTR information to the client 700 as a DNS reply message.

The message reception unit 704 receives a message comprising at least one NAPTR record from the server 720, each NAPTR record comprising a URI and an identifier of a user of the URI. In other words, the message reception unit 704 receives a DNS reply message transmitted by the message transmission unit 724.

The URI selection unit 706 determines which of the NAPTR records included in the message received by the message reception unit 704 is to be used by referencing the identifiers respectively included in the NAPTR records. In other words, the URI selection unit 706 chooses one of a plurality of NAPTR records included in a DNS reply message received by the message reception unit 704 as a URI to be used by the client 700 by referencing the identifiers respectively in the NAPTR records.

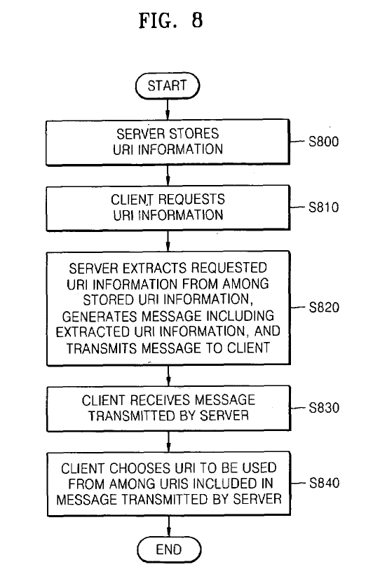

FIG. 8 is a flowchart illustrating a method of acquiring a URI according to an embodiment of the present invention, i.e., the operation of the system illustrated in FIG. 7. Referring to FIG. 8, in operation S800, NAPTR information comprising at least one URI and an identifier of a user of the URI is stored in the URI information storage unit 722. i.e., one or more NAPTR records are stored in the URI information storage unit 722, each NAPTR record comprising a URI and an identifier of a user of the URI. In addition to an identifier of a user of a URI, each NAPTR record stored in the URI information storage unit 722 may further comprise information indicating the types of services using the URI and information indicating at least one platform using the URI. Here, information indicating the types of services using a URI and information indicating at least one platform using the URI may be recorded in a field “SERVICES” of an NAPTR record.

Thereafter, in operation S810, the URI information request unit 702 transmits a signal indicating URI information that is requested by the client 700 to the server 720. If the server 720 is a DNS server, the signal transmitted by the URI information request unit 702 may be a DNS query message containing an NAPTR record.

In operation S820, when the signal transmitted by the URI information request unit 702 is received, the message transmission unit 724 extracts NAPTR information corresponding to the URI information requested by the client 700 from the URI information storage unit 722 with reference to the received signal, and transmits a message containing the extracted NAPTR information to the client 700. If the server 720 is a DNS server, then the message transmission unit 724 may extract NAPTR information (as illustrated in FIG. 5B) corresponding to the requested URI information from a zone setting file (as illustrated in FIG. 5A) present in the URI information storage unit 722 based on a DNS query message, and transmit the extracted NAPTR information to the client 700 as a DNS reply message.

In operation S830, the message reception unit 704 receives the message transmitted by the message transmission unit 724, i.e., a DNS reply message transmitted by the message transmission unit 724.

In operation S840, the URI selection unit 706 chooses one of a plurality of NAPTR records included in the message received by the message reception unit 704 as an NAPTR record to be used by the client 700 by referencing a plurality of identifiers respectively included in the NAPTR records, and chooses a URI included in the chosen NAPTR record. In other words, the URI selection unit 706 chooses one of a plurality of URIs included in a DNS reply message received by the message reception unit 704 as a URI to be used by the client 700 by referencing the identifiers of the URIs.

As described above, according to the present invention, an identifier of a URI is included in an NAPTR record by expanding an existing NAPTR record format, as illustrated in FIG. 2, or by using a field “SERVICES” of an existing NAPTR record. However, the present invention is not restricted thereto. In other words, the present invention may be applied to various methods as long as they provide means of displaying identifiers of users of information services using an existing NAPTR record format.

The present invention can be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that computer-readable code is written thereto and executed therefrom in a decentralized manner. Functional programs, code, and code segments needed for realizing the present invention can be easily construed by one of ordinary skill in the art.

According to the present invention, it is possible for a user of an information service associated with products or cultural assets to effectively extract information that suits the user most from among a plurality of pieces of information included in the information service. In other words, according to the present invention, even when more than one client uses an information service associated with cultural assets, electronic products, or movie posters, it is possible to effectively provide each client with information of interest.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A client for acquiring a uniform resource identifier (URI), the client comprising:
a message reception unit which receives a plurality of naming authority pointer (NAPTR) records from a domain name service (DNS) server, each of the NAPTR records comprising a URI and an identifier of a user of the URI; and
a URI selection unit which chooses one of the URIs respectively included in the NAPTR records by referencing the identifiers respectively included in the NAPTR records.

2. The client of claim 1, wherein an identifier of a user of a URI is recorded in an arbitrary format in one of a plurality of existing fields of an NAPTR record.

3. The client of claim 1, wherein an identifier of a user of a URI is recorded in an arbitrary format in a new field that is added to an NAPTR record.

4. The client of claim 2, wherein an identifier of a user of a URI is recorded in a field ‘services’ of an NAPTR record.

5. A computer-readable recording medium storing an NAPTR having a data structure that comprises a URI and an identifier of a user of the URI in order to choose a URI desired by a client from among a plurality of URIs respectively included in a plurality of NAPTR records.

6. The computer-readable recording medium of claim 5, wherein an identifier of a user of a URI is recorded in an arbitrary format in one of a plurality of existing fields of an NAPTR record.

7. The computer-readable recording medium of claim 5, wherein an identifier of a user of a URI is recorded in an arbitrary format in a new field that is added to an NAPTR record.

8. A method of acquiring a uniform resource identifier (URI) of a client, the method comprising:
receiving a plurality of naming authority pointer (NAPTR) records from a domain name service (DNS) server, each of the NAPTR records comprising a URI and an identifier of a user of the URI; and
choosing one of the URIs respectively included in the NAPTR records by referencing the identifiers respectively included in the NAPTR records.

9. The method of claim 8, wherein an identifier of a user of a URI is recorded in an arbitrary format in one of a plurality of existing fields of an NAPTR record.

10. The method of claim 8, wherein an identifier of a user of a URI is recorded in an arbitrary format in a new field that is added to an NAPTR record.

11. A computer-readable recording medium storing a computer program for executing the method of claim 8.

12. A computer-readable recording medium storing a computer program for executing the method of claim 9.

13. A computer-readable recording medium storing a computer program for executing the method of claim 10.
